(19) United States
(12) Patent Application Publication
(10) Pub. No.: US 2022/0036308 A1
(43) Pub. Date: Feb. 3, 2022

(54) TOILET PAPER ROLL DELIVERY SYSTEM, TOILET PAPER HOLDER, SERVER, AND METHOD THEREFOR

(71) Applicant: KYOCERA Corporation, Kyoto (JP)

(72) Inventor: Takaomi ARAKI, Yokohama-shi (JP)

(73) Assignee: KYOCERA Corporation, Kyoto (JP)

(21) Appl. No.: 17/500,513

(22) Filed: Oct. 13, 2021

Related U.S. Application Data
(63) Continuation of application No. PCT/JP2020/014939, filed on Mar. 31, 2020.

(30) Foreign Application Priority Data
Apr. 23, 2019 (JP) 2019-082344

(51) Int. Cl. G06Q 10/08; A47K 10/32

(52) U.S. Cl. CPC G06Q 10/0875; A47K 2010/3226; A47K 10/32

(57) ABSTRACT

In a toilet paper roll delivery system (1) including a toilet paper holder (10); and a server (30) that stores history information related to product purchase history for a consumer or product delivery history for the consumer, the toilet paper holder (10) detects a change in a mounting state of a toilet paper roll (3) mounted on the toilet paper holder (10), and transmits detection information corresponding to a result of the detection to the server (30), and the server (30) receives the detection information, and performs, based at least on the detection information and the history information, a process for delivering a replenishment product of the same type as the toilet paper roll (3) to the consumer.

### RELATED APPLICATIONS

The present application is a continuation based on PCT Application No. PCT/JP2020/014939, filed on Mar. 31, 2020, which claims the benefit of Japanese Patent Application No. 2019-082344 filed on Apr. 23, 2019. The content of which is incorporated by reference herein in their entirety.

### TECHNICAL FIELD

The present disclosure relates to a toilet paper roll delivery system, a toilet paper holder, a server, and a method therefor.

### BACKGROUND ART

Conventionally, there are known home devices that are capable of automatically measuring the amount of consumer goods remaining and automatically reordering the consumer goods (for example, see Non-Patent Document 1).

### CITATION LIST

### Non-Patent Literature

Non-Patent Document 1: “Amazon Dash Replenishment”, [online], [Searched on Apr. 8, 2019], internet <URL: https://www.amazon.co.jp/b?ie=UTF8&node=4830978051&tag=yahhyd-22&hvadid=318500059105 &hvdev=c&ref=pd_s1_8q1ur99hwd_b>

### SUMMARY

A toilet paper roll delivery system according to a first aspect includes: a toilet paper holder; and a server configured to store history information related to product purchase history for a consumer or product delivery history for the consumer, wherein the toilet paper holder is configured to detect a change in a mounting state of a toilet paper roll mounted on the toilet paper holder, and transmit detection information corresponding to a result of the detection to the server, and the server is configured to receive the detection information, and perform, based at least on the detection information and the history information, a process for delivering a replenishment product of the same type as the toilet paper roll to the consumer.

A toilet paper holder according to a second aspect includes: a detector configured to detect a change in a mounting state of a toilet paper roll mounted on the toilet paper holder; and a communicator configured to transmit detection information corresponding to a detection result from the detector to an external server.

A server according to a third aspect includes: a storage configured to store history information related to product purchase history for a consumer or product delivery history for the consumer; a communicator configured to receive, from an external toilet paper holder, detection information corresponding to detection of a change in a mounting state of a toilet paper roll mounted on the toilet paper holder; and a controller configured to perform, based at least on the detection information and the history information, a process for delivering a replenishment product of the same type as the toilet paper roll to the consumer.

A method performed in a toilet paper roll delivery system according to a fourth aspect includes: storing history information related to product purchase history for a consumer or product delivery history for the consumer; receiving, from an external toilet paper holder, detection information corresponding to detection of a change in a mounting state of a toilet paper roll mounted on the toilet paper holder; and performing, based at least on the detection information and the history information, a process for delivering a replenishment product of the same type as the toilet paper roll to the consumer.

### BRIEF DESCRIPTION OF DRAWINGS

FIG. 1 is a diagram illustrating an example of an overall configuration of a toilet paper roll delivery system 1 according to an embodiment.

FIG. 2 is a diagram illustrating an example of a functional block of a toilet paper holder 10 according to an embodiment.

FIG. 3 is a diagram illustrating an example of a configuration of a message generated by the toilet paper holder 10 according to an embodiment.

FIG. 4A is a diagram illustrating an example of a structure of the toilet paper holder 10 according to an embodiment.

FIG. 4B is a diagram illustrating an example of a structure of the toilet paper holder 10 according to an embodiment.

FIG. 5 is a diagram illustrating an example of a structure of the toilet paper holder 10 according to an embodiment.

FIG. 6A is a diagram illustrating an example of a structure of the toilet paper holder 10 according to an embodiment.

FIG. 6B is a diagram illustrating an example of a structure of the toilet paper holder 10 according to an embodiment.

FIG. 7 is a diagram illustrating an example of a structure of the toilet paper holder 10 according to an embodiment.

FIG. 8 is a diagram illustrating an example of a structure of the toilet paper holder 10 according to an embodiment.

FIG. 9 is a diagram illustrating an example of a functional block of a server 30 according to an embodiment.

FIG. 10A is a diagram illustrating an example of consumer information managed by the server 30 according to an embodiment.

FIG. 10B is a diagram illustrating an example of consumer information managed by the server 30 according to an embodiment.

FIG. 11 is a diagram illustrating an example of product information managed by the server 30 according to an embodiment.

FIG. 12 is a diagram illustrating an example of a method of identifying a consumption cycle according to an embodiment.

FIG. 13 is a diagram illustrating an example of a method of determining delivery timing according to an embodiment.

FIG. 14 is a diagram illustrating an example of a method of determining collective delivery timing according to an embodiment.

FIG. 15 is a sequence diagram illustrating an example of operations of the toilet paper roll delivery system 1 according to an embodiment.

### DESCRIPTION OF EMBODIMENTS

In a conventional home device, there is a problem in that consumer goods which can be automatically reordered are limited in terms of type.

Thus, the present disclosure has been made in view of the above-described problem, and enables automatic measurement of the remaining amount of toilet paper roll in each consumer's house and automatic delivery of toilet paper.

Embodiments will be described below with reference to the drawings. Note that in the following description of the drawings, the same or similar components will be denoted by the same or similar reference signs.

However, it should be noted that the drawings are schematic and the ratio of dimensions and the like may differ from actual ones. Thus, specific dimensions and the like should be determined with reference to the following description. It is a matter of course that portions having dimensional relationships or ratios that differ between drawings may be included.

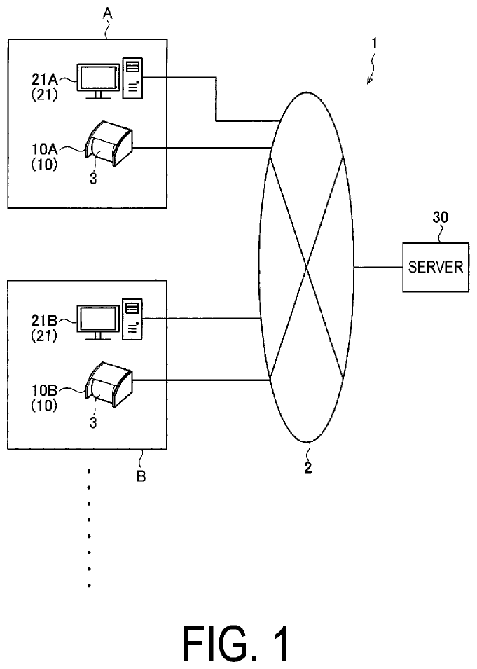

An embodiment will be described below with reference to FIGS. 1 to 15.

### Toilet Paper Roll Delivery System

FIG. 1 is a diagram illustrating an example of an overall configuration of a toilet paper roll delivery system 1 according to the present embodiment. The toilet paper roll delivery system 1 manages delivery of a toilet paper roll 3 to consumers.

FIG. 1 illustrates a plurality of consumer houses A and B corresponding to a plurality of consumers utilizing a delivery service provided by the toilet paper roll delivery system 1. The delivery service according to the present embodiment is a delivery service for delivering the toilet paper roll 3 to the plurality of consumer houses A and B. Note that the consumer houses A and B may each be a detached residence or in a housing complex such as an apartment house or a condominium. Also, the consumer houses A and B are not limited to private homes, but may be stores or facilities that consume toilet paper.

As illustrated in FIG. 1, the consumer houses A and B are provided with toilet paper holders 10 (10A and 10B) and communication apparatuses 21 (21A and 21B). The communication apparatus 21 includes, but is not limited to, a communication terminal such as a so-called smartphone, a tablet, a laptop computer, a desktop computer, and a smart speaker.

The toilet paper holder 10 and the communication apparatus 21 have a function of being capable of communicating with a server 30 via a communication network 2.

### Toilet Paper Holder 10

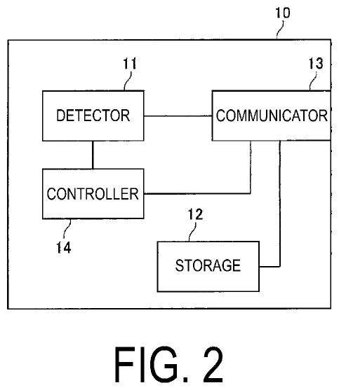

As illustrated in FIG. 2, the toilet paper holder 10 includes a detector 11, a storage 12, a communicator 13, and a controller 14.

The detector 11 detects a change in a mounting state of the toilet paper roll 3 that is mounted on the toilet paper holder 10.

For example, the detector 11 may detect, as such a change in the mounting state, that the toilet paper roll 3 has been newly mounted, that the toilet paper roll 3 has been removed, or that the toilet paper roll 3 has been replaced.

The controller 14 generates a message including detection information corresponding to a result of the above-described detection. Here, the controller 14 may generate the above-described message each time a change in the mounting state of the toilet paper roll 3 is detected.

The storage 12 includes a storage device such as a Ferroelectric Random Access Memory (FRAM) (trade name). The storage 12 stores a consumer ID (first consumer identification information) that identifies the consumer houses A and B.

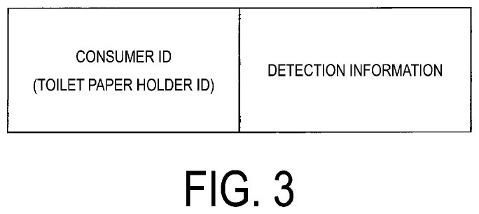

Note that, as illustrated in FIG. 3, in the above-described message, the controller 14 may associate the consumer ID (first consumer identification information) with the detection information. Alternatively, in the above-described message, the controller 14 may associate a toilet paper holder ID corresponding to the consumer ID with the detection information. The association between the consumer ID and the toilet paper holder ID may be performed by an operation of the consumer via the communication apparatus 21. In this case, the association between the consumer ID and the toilet paper holder ID may be performed by direct communication between the toilet paper holder 10 and the communication apparatus 21. Alternatively, the association between the consumer ID and the toilet paper holder ID may be performed at the time of shipment of the toilet paper holder 10.

Here, for example, the detection information may be a flag that is set to “1” when it is detected that the toilet paper roll 3 has been newly mounted as the mounting state, “2” when it is detected that the toilet paper roll 3 has been removed as the mounting state, and “3” when it is detected that the toilet paper roll 3 has been replaced as the mounting state. Furthermore, the detection information may be a value itself that indicates the detection result of the detector 11. The detection information is not limited in content and format as long as the detection information is information capable of identifying the detection result of the detector 11.

The communicator 13 performs wireless communication (for example, LPWA type wireless communication) with the communication network 2 and communicates with the server 30 via the communication network 2.

Here, the communicator 13 converts the message input from the controller 14 into a radio signal, and transmits the wireless signal via an antenna. Note that the communicator 13 may transmit such a message to the server 30 each time the above-described message is generated, in other words, a plurality of times.

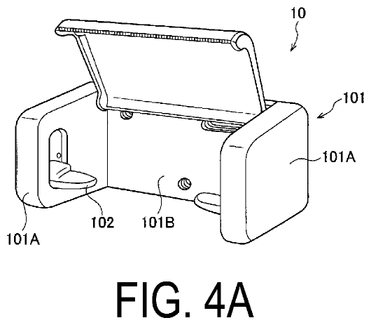

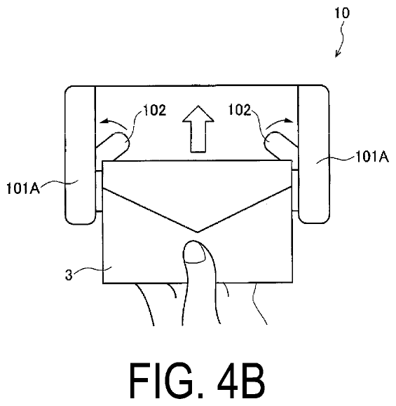

As illustrated in FIGS. 4A and 4B, the toilet paper holder 10 may include a body 101 and a pair of core rod levers 102.

The body 101 includes at least side portions 101A on right and left sides and a wall surface mounting portion 101B on a back side.

The pair of core rod levers 102 are provided on the side portions 101A on right and left sides, are inserted into the cylindrical core of the toilet paper roll 3 to rotatably support the toilet paper roll 3 from both sides, and can tilt in any of the upper direction, the lower direction, the front direction, and the rear direction.

In a case where the toilet paper holder 10 has the structure illustrated in FIGS. 4A and 4B, the detector 11 may detect whether the core rod levers 102 have tilted and detect, by such detection, a change in the mounting state of the toilet paper roll 3.

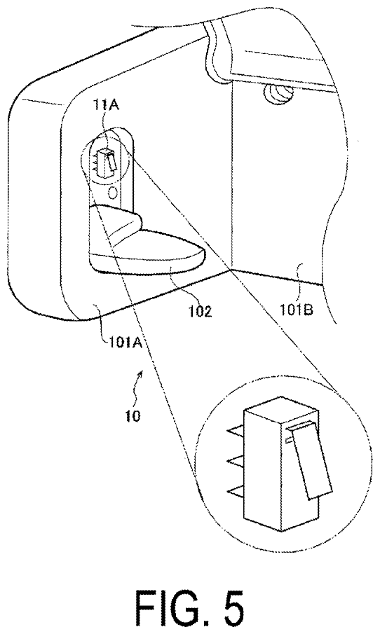

In such a case, as illustrated in FIG. 5, the detector 11 includes a microswitch (switch mechanism) 11A that detects that the core rod lever 102 has tilted, and the microswitch 11A may be provided on the side portion 101A. Specifically, as illustrated in FIG. 5, a recess that accommodates the core rod lever 102 when the core rod lever 102 tilts is provided on the side portion 101A, and the microswitch 11A may be provided in the recess.

Note that the communicator 13 may be provided inside the side portion 101A or the wall surface mounting portion 101B.

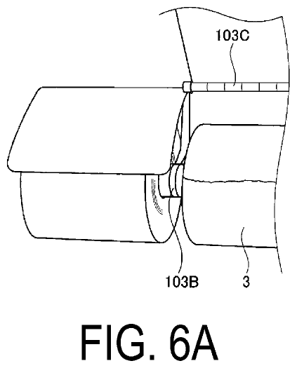

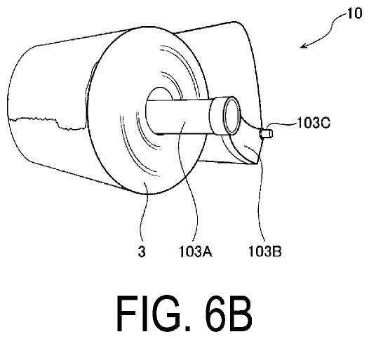

Alternatively, as illustrated in FIGS. 6A and 6B, the toilet paper holder 10 includes a pair of arms 103B. Here, the arms 103B support a core rod bar 103A inserted into the cylindrical core of the toilet paper roll 3 from both sides at a fixed position, and release the core rod bar 103A at a position moved in the upper direction from the fixed position.

In a case where the toilet paper holder 10 has the structure illustrated in FIGS. 6A and 6B, the detector 11 detects whether the arms 103B have moved in the upper direction, and detects, by such detection, a change in the mounting state of the toilet paper roll 3.

Specifically, as illustrated in FIGS. 6A and 6B, the toilet paper holder 10 is provided with a hinge mechanism 103C that is capable of moving the arms 103B in the upper direction, and the hinge mechanism 103C may detect that the arms 103B have moved in the upper direction.

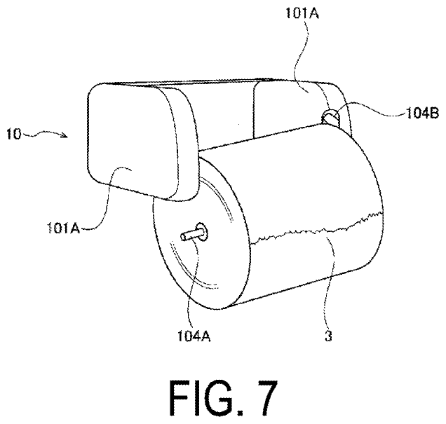

Alternatively, as illustrated in FIG. 7, the toilet paper holder 10 may include a body 101 and support holes 104B.

The support holes 104B are provided on the side portions 101A on right and left sides, and support, from both sides, a core rod bar 104A that is inserted into the cylindrical core of the toilet paper roll 3.

In a case where the toilet paper holder 10 has the structure illustrated in FIG. 7, the detector 11 may include a detection button provided in the support hole 104B, detect whether the detection button is depressed, and detect, by such a detection, a change in the mounting state of the toilet paper roll 3.

For example, when the core rod bar 104A is removed from the toilet paper holder 10, the above-described detection button becomes in a state of not being depressed, and, consequently, the detector 11 may detect that the toilet paper roll 3 has been replaced.

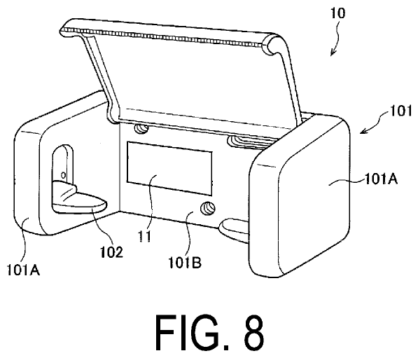

Alternatively, as illustrated in FIG. 8, the detector 11 may be provided on the wall surface mounting portion 101B. In this case, the detector 11 may include an illuminance sensor. The illuminance sensor detects a change in ambient illuminance and detects, by such a change, a change in the mounting state of the toilet paper roll 3. The detector 11 may include a proximity sensor. The proximity sensor may detect, based on a magnetic and/or capacitance change and the like, a change in a distance to a surrounding object and may detect, by such a change, a change in the mounting state of the toilet paper roll 3. The detector 11 may include both an illuminance sensor and a proximity sensor.

Such an illuminance sensor or a proximity sensor may be provided in an empty region other than the wall surface mounting portion 101B. Such an illuminance sensor or a proximity sensor may also be detachable from the toilet paper holder 10.

### Server 30

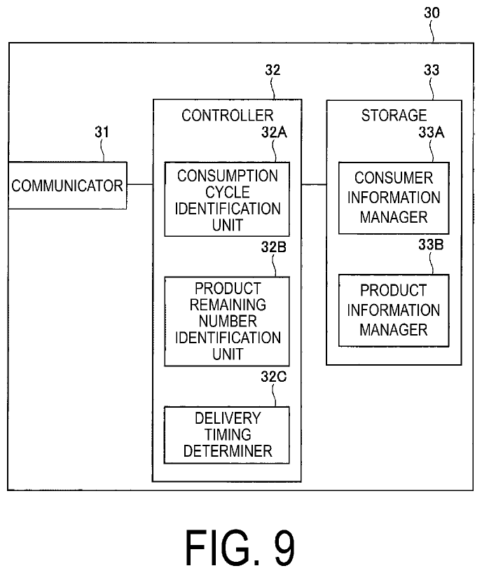

As illustrated in FIG. 9, the server 30 includes a communicator 31, a controller 32, and a storage 33.

The communicator 31 includes a communication module and communicates with the toilet paper holder 10 via the communication network 2.

The communicator 31 receives a message (see FIG. 3) from the external toilet paper holder 10 via the communication network 2.

The controller 32 includes at least one processor and at least one memory. The controller 32 performs various processes.

The storage 33 includes an auxiliary storage device such as a hard disk or flash memory. The storage 33 stores various types of information used for processes in the controller 32.

As illustrated in FIG. 9, the storage 33 includes a consumer information manager 33A and a product information manager 33B.

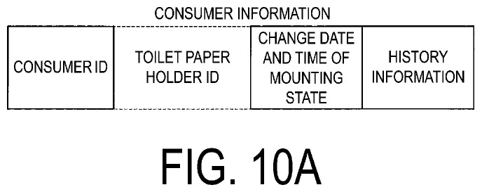

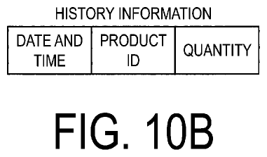

As illustrated in FIG. 10A, the consumer information manager 33A manages consumer information that associates the consumer ID, the toilet paper holder ID, a change date and time of the mounting state and the history information with each other. Such consumer information may further include information related to a home delivery service, such as information related to an address and a payment and/or point information of the consumer.

Note that the toilet paper holder ID in the consumer information is used to convert the toilet paper holder ID to the consumer ID in a case where the toilet paper holder ID is included in the message from the toilet paper holder 10.

Thus, in a case where the consumer ID is included in the message from the toilet paper holder 10, the toilet paper holder ID in the consumer information may be unnecessary.

Conversely, in a case where the server 30 stores the toilet paper holder ID and the consumer ID of a consumer to whom the toilet paper holder 10 having the toilet paper holder ID is delivered in association with each other, since the consumer information need only include the toilet paper holder ID, the consumer ID in the consumer information may be unnecessary.

The consumer information manager 33A manages, based on the message from the toilet paper holder 10, a change date and time of the mounting state in the consumer information.

The change date and time of the mounting state may be the date and time when the message is received from the toilet paper holder 10 (or the date and time when the change in the mounting state of the toilet paper holder 10 is detected by the toilet paper holder 10).

The consumer information manager 33A manages, based on the delivery content to the consumer, the history information in the consumer information.

The history information is related to product purchase history for the consumer or product delivery history for delivery to the consumer. As illustrated in FIG. 10B, the history information includes the date and time when the product (toilet paper roll 3) was delivered to the consumer (or the date and time when the product was purchased by the consumer) and the product ID of the delivered product. In a case where a plurality of products of the same type are collectively delivered to the consumer (i.e., collective delivery), the history information may further include the quantity of delivered plurality of products of the same type.

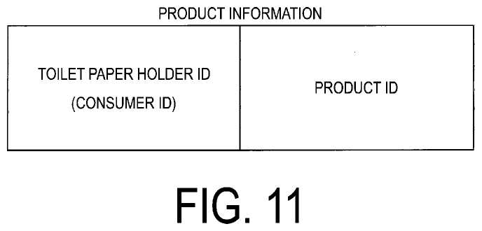

As illustrated in FIG. 11, the product information manager 33B manages product information that associates the toilet paper holder ID (or the consumer ID) and the product ID with each other. Such product information is information for identifying a product to be delivered to the consumer corresponding to the toilet paper holder ID (or the consumer ID) when a change in the mounting state of the toilet paper roll 3 that is mounted on the toilet paper holder 10 identified by the toilet paper holder ID (or the consumer ID) is detected.

The controller 32 performs, based at least on the detection information included in a message received by the communicator 31 and the history information managed by the consumer information manager 33A, a process for delivering, to the consumer, a replenishment product of the same type as the toilet paper roll 3 identified by the consumer ID (the toilet paper holder ID) included in such a message.

The replenishment product may be a product included in the history information or may be a product not included in the history information of the same type as the toilet paper roll 3. The replenishment product may be selected by the consumer via the communication apparatus 21 or determined by presenting a candidate for the replenishment product. Note that the presentation of the candidate of the replenishment product may be performed in a case where the history information includes two or more products of the same type as the toilet paper roll 3.

Here, in the controller 32, a case is assumed in which the consumer ID (first consumer identification information) included in the message received by the communicator 31 and the consumer ID (second consumer identification information) in the consumer information managed by the consumer information manager 33A match. In this case, the controller 32 may perform, based on the detection information included in such a message and the history information in such consumer information, a process for delivering, to the consumer identified by the consumer ID, the replenishment product of the same type as the toilet paper roll 3 identified by the consumer ID (the toilet paper holder ID) included in such a message.

As illustrated in FIG. 9, the controller 32 includes a consumption cycle identification unit 32A, a product remaining number identification unit 32B, and a delivery timing determiner 32C.

The consumption cycle identification unit 32A identifies and manages, based on the history information in the consumer information managed by the consumer information manager 33A, a consumption cycle in which the consumer consumes one product.

For example, the consumption cycle identification unit 32A can consider the date and time when the toilet paper roll 3 is newly mounted, the date and time when the toilet paper roll 3 is removed, or the date and time when the toilet paper roll 3 is replaced, as a consumption start date and time (consumption start timing) of such a toilet paper roll 3.

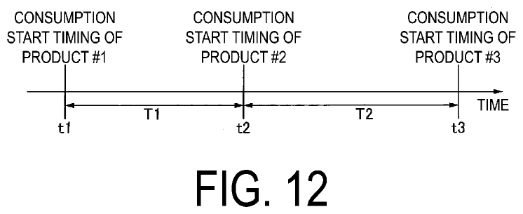

Specifically, in the example illustrated in FIG. 12, the consumption cycle identification unit 32A specifies that a consumption start timing of a product #1 is t1, a consumption start timing of a product #2 is t2, and a consumption start timing of a product #3 is t3. In this example, the consumption cycle identification unit 32A calculates an average of the time T1 from t1 to t2 and the time T2 from t2 to t3, and identifies the calculated value as the consumption cycle corresponding to such a product.

In a case where a plurality of products of the same type are collectively delivered (collective delivery) to the consumer, the product remaining number identification unit 32B identifies, based on the history information related to the product purchase history for the consumer or the product delivery history for the consumer and the detection information included in the message from the toilet paper holder 10, the remaining number of a plurality of products of the same type which is possessed by the consumer. The product remaining number identification unit 32B is capable of identifying the current remaining number by decrementing (i.e., subtracting 1 from) the quantity of the plurality of products of the same type delivered to the consumer each time the product starts to be used. Note that the quantity of the plurality of products of the same type at the time when the product remaining number identification unit 32B starts the decrement in response to the detection information may be determined by asking the consumer a question via the communication apparatus 21 and obtaining the answer.

The delivery timing determiner 32C determines, based on the consumption cycle identified by the consumption cycle identification unit 32A, the delivery timing for delivering the replenishment product to the consumer. As a result, the delivery timing determiner 32C can deliver the replenishment product at a delivery timing suitable for the consumer by using the results of the learning in the server 30.

The delivery timing determiner 32C determines, based on the consumption start timing corresponding to a timing at which the change in the mounting state of the toilet paper roll 3 is detected by the toilet paper holder 10 and the consumption cycle identified by the consumption cycle identification unit 32A, the delivery timing of the replenishment product.

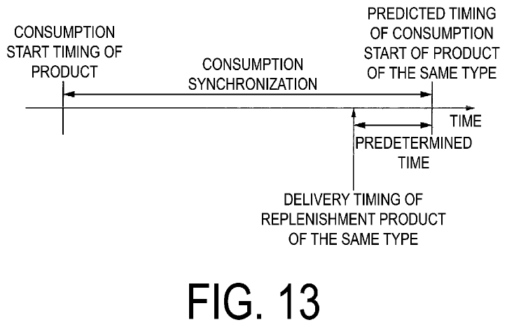

For example, as illustrated in FIG. 13, the delivery timing determiner 32C adds the consumption cycle identified by the consumption cycle identification unit 32A to the consumption start timing corresponding to the timing at which the change in the mounting state of the toilet paper roll 3 is detected by the toilet paper holder 10. Thus, the delivery timing determiner 32C predicts the timing at which the consumer next starts the consumption of the product of the same type as the product corresponding to the toilet paper holder 10 (the consumer) (i.e., predicted timing of consumption start of the product of the same type).

Then, the delivery timing determiner 32C determines the predicted timing of consumption start or a timing of a predetermined time before the predicted timing of consumption start as the delivery timing of the replenishment product.

FIG. 13 illustrates an example in which the delivery timing determiner 32C determines the timing of the predetermined time before the predicted timing of consumption start as the delivery timing of the replenishment product. As a result, the delivery timing determiner 32C can deliver the replenishment product to the consumer at the appropriate timing. The predetermined time may be settable for each type of product by the consumer.

Alternatively, the delivery timing determiner 32C may set the predetermined time for each type of product depending on the characteristics of the product.

The storage 33 may store in advance a delivery cycle (default delivery cycle) set for each type of product. The default delivery cycle may be a delivery cycle that is automatically set when the consumer utilizes a regular delivery service.

The delivery timing determiner 32C may determine the delivery timing of the replenishment product by changing the delivery cycle stored in advance, based on the consumption cycle identified by the consumption cycle identification unit 32A. As a result, the delivery timing determiner 32C can automatically change the delivery cycle in the regular delivery service according to a consumption situation of the consumer.

In a case where a plurality of products of the same type are collectively delivered (collective delivery) to the consumer, the delivery timing determiner 32C may determine, based on the consumption cycle identified by the consumption cycle identification unit 32A, and the remaining number identified by the product remaining number identification unit 32B, the delivery timing for collectively delivering (collective delivery) a plurality of the replenishment products to the consumer.

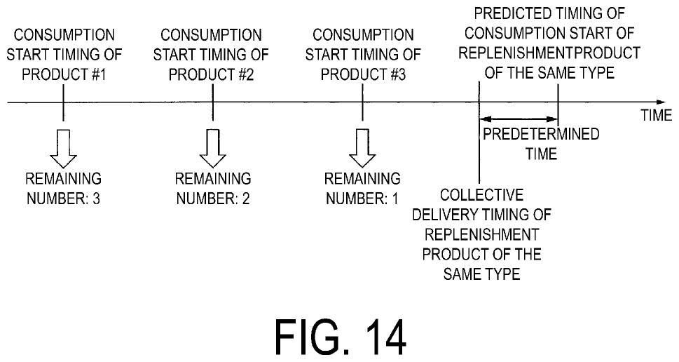

For example, when the change in the mounting state of the toilet paper roll 3 is detected by the toilet paper holder 10, the delivery timing determiner 32C can determine the collective delivery timing of the replenishment product in the following manner. FIG. 14 illustrates an example of determining delivery timing in a case where three products of the same type are collectively delivered (collective delivery) to the consumer.

As illustrated in FIG. 14, the product remaining number identification unit 32B identifies the current remaining number by decrementing (i.e., subtracting 1 from) the quantity (three) of the plurality of products of the same type delivered to the consumer each time the product starts to be used.

When the consumption of the last one of the three products of the same type starts, the delivery timing determiner 32C adds the consumption cycle identified by the consumption cycle identification unit 32A to the consumption start timing of the last one product. As a result, the delivery timing determiner 32C predicts the timing at which the consumer next starts the consumption of the product of the same type (predicted timing of consumption start).

Then, the delivery timing determiner 32C determines the predicted timing of consumption start or the timing of a predetermined time before the predicted timing of consumption start as the collective delivery timing of the replenishment product. FIG. 14 illustrates an example in which the delivery timing determiner 32C determines the timing of the predetermined time before the predicted timing of consumption start as the collective delivery timing of the replenishment product.

Note that the controller 32 may perform, simply based on the identified remaining number of the toilet paper rolls 3, the process for delivering the replenishment product of the same type as the toilet paper roll 3. In other words, the controller 32 determines, based on the detection information included in the plurality of messages and the history information included in the consumer information, whether the total number of the toilet paper rolls 3 possessed by a consumer identified by the consumer ID included in the messages has dropped below a threshold. In a case where the controller 32 determines that the total number of the toilet paper rolls 3 has dropped below the threshold, the controller 32 may perform the process for delivering the replenishment product of the same type as the toilet paper roll 3 identified by the consumer ID (the toilet paper holder ID) included in such messages.

Note that, when the delivery timing is determined by the delivery timing determiner 32C, the controller 32 may notify the determined delivery timing and the type, quantity, and the like of the product to be delivered to, for example, a server or a terminal of a distributor via the communicator 31. Alternatively, the controller 32 may present the determined delivery timing and information such as type and quantity of the product to be delivered, to a delivery operator or the like by a display.

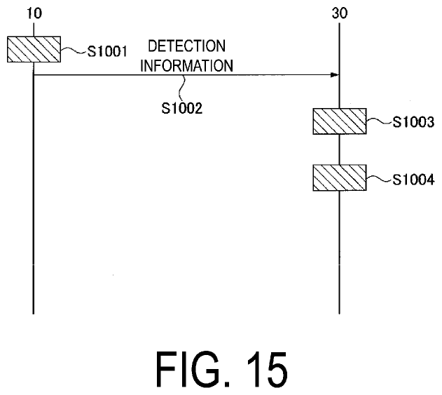

Operation Sequence FIG. 15 is a sequence diagram illustrating an example of an operation of the toilet paper roll delivery system 1 according to the present embodiment.

As illustrated in FIG. 15, the toilet paper holder 10 detects a change in the mounting state of the toilet paper roll 3 that is mounted on the toilet paper holder 10 in step S1001. The toilet paper holder 10 transmits a message including detection information corresponding to such a detection result to the server 30 in step S1002.

The server 30 receives the above-described message in step S1003, and performs, based on the detection information included in such a message and the history information included in the consumer information including the same consumer ID as the consumer ID included in such a message, a process for delivering a replenishment product of the same type as the product (toilet paper roll 3) identified by the product ID included in such history information (or the product ID included in the product information including such a consumer ID) in step S1004.

According to the toilet paper roll delivery system 1 according to the present embodiment, it is possible to automatically measure the remaining amount of toilet paper roll in each consumer's house and automatically deliver toilet paper.

A program for causing a computer to execute each process performed by the toilet paper holder 10 or the server 30 may be provided. The program may be recorded in a computer readable medium. Use of a computer readable medium enables the program to be installed on a computer. Here, the computer readable medium on which the program is recorded may be a non-transitory recording medium. The non-transitory recording medium is not particularly limited, and may be, for example, a recording medium such as a CD-ROM, a DVD-ROM, or the like.

Embodiments have been described above in detail with reference to the drawings, but specific configurations are not limited to those described above, and various design modifications can be made without departing from the gist of the present disclosure.

1. A toilet paper roll delivery system comprising:
a toilet paper holder; and
a server configured to store history information related to product purchase history for a consumer or product delivery history for the consumer, wherein
the toilet paper holder is configured to
detect a change in a mounting state of a toilet paper roll mounted on the toilet paper holder, and
transmit detection information corresponding to a result of the detection to the server, and
the server is configured to
receive the detection information, and
perform, based at least on the detection information and the history information, a process for delivering a replenishment product of the same type as the toilet paper roll to the consumer.

2. The toilet paper roll delivery system according to claim 1, wherein
the change in the mounting state includes at least one of the toilet paper roll being newly mounted, the toilet paper roll being removed, and the toilet paper roll being replaced.

3. The toilet paper roll delivery system according to claim 1, wherein
the toilet paper holder is configured to
store first consumer identification information for identifying the consumer, and
transmit, to the server, the first consumer identification information in association with the detection information, and
the server is configured to
receive the first consumer identification information in association with the detection information,
store at least one piece of second consumer identification information for identifying the consumer, in association with the history information, and
perform, based on the detection information and the history information, the process when it is determined that the first consumer identification information and the second consumer identification information match.

4. The toilet paper roll delivery system according to claim 1, wherein
the toilet paper holder is configured to transmit the detection information to the server a plurality of times, and
the server is configured to
determine, based on the detection information and the history information, whether the remaining number of toilet paper rolls possessed by the consumer falls below a threshold, and perform the process when it is determined that the remaining number of toilet paper rolls falls below the threshold.

5. A toilet paper holder comprising:
a detector configured to detect a change in a mounting state of a toilet paper roll mounted on the toilet paper holder; and
a communicator configured to transmit detection information corresponding to a detection result from the detector to an external server.

6. The toilet paper holder according to claim 5, comprising:
a body including at least side portions on right and left sides, and a wall surface mounting portion on a back side; and
a pair of core rod levers provided on the side portions on right and left sides, to be inserted into a cylindrical core of the toilet paper roll to rotatably support the toilet paper roll from both sides and configured to be capable of tilting in any of an upper direction, a lower direction, a front direction, and a rear direction, wherein
the detector is configured to detect whether at least one of the core rod levers is tilted to detect the change in the mounting state by the detection.

7. The toilet paper holder according to claim 6, wherein
the detector includes a microswitch configured to detect that at least one of the core rod levers is tilted, the microswitch being provided on any of the side portions.

8. The toilet paper holder according to claim 5, comprising:
a pair of arms configured to support a core rod bar inserted into a cylindrical core of the toilet paper roll from both sides at a fixed position and release the core rod bar at a position moved in the upper direction from the fixed position, wherein
the detector is configured to detect whether at least one of the arms is moved in an upper direction and, by the detection, detects the change in the mounting state.

9. The toilet paper holder according to claim 5, comprising:
a body including at least side portions on right and left sides, and a wall surface mounting portion on a back side; and
support holes provided on the side portions on right and left sides and configured to support a core rod bar inserted into a cylindrical core of the toilet paper roll from both sides, wherein
the detector is provided in at least one of the support holes, is configured to detect whether the detector is depressed, and, by the detection, detects the change in the mounting state.

10. The toilet paper holder according to claim 5, comprising:
a body including at least side portions on right and left sides, and a wall surface mounting portion on a back side, wherein
the detector is provided on the wall surface mounting portion, is configured to detect a change in ambient illuminance, and, by the change in the ambient illuminance, detects the change in the mounting state.

11. The toilet paper holder according to claim 5, comprising:
a body including at least side portions on right and left sides, and a wall surface mounting portion on a back side, wherein
the detector is provided on the wall surface mounting portion, is configured to detect a change in a distance to a surrounding object, and, by the change in the distance to the surrounding object, detects the change in the mounting state.

12. A server comprising:
a storage configured to store history information related to a product purchase history for a consumer or a product delivery history for the consumer;
a communicator configured to receive, from an external toilet paper holder, detection information corresponding to detection of a change in a mounting state of a toilet paper roll mounted on the toilet paper holder; and
a controller configured to perform, based at least on the detection information and the history information, a process for delivering a replenishment product of the same type as the toilet paper roll to the consumer.

13. A method performed in a toilet paper roll delivery system, the method comprising:
storing history information related to product purchase history for a consumer or product delivery history for the consumer;
receiving, from an external toilet paper holder, detection information corresponding to detection of a change in a mounting state of a toilet paper roll mounted on the toilet paper holder; and
performing, based at least on the detection information and the history information, a process for delivering a replenishment product of the same type as the toilet paper roll to the consumer.
